(19) United States
(12) Patent Application Publication
(10) Pub. No.: US 2022/0398400 A1
(43) Pub. Date: Dec. 15, 2022

(54) METHODS AND APPARATUSES FOR DETERMINING OBJECT CLASSIFICATION

(71) Applicant: SENSETIME INTERNATIONAL PTE. LTD., Singapore (SG)

(72) Inventors: Jinghuan Chen, Singapore (SG); Chunya Liu, Singapore (SG); Xuesen Zhang, Singapore (SG); Bairun Wang, Singapore (SG)

(21) Appl. No.: 17/364,423

(22) Filed: Jun. 30, 2021

Related U.S. Application Data
(63) Continuation of application No. PCT/IB2021/055781, filed on Jun. 29, 2021.

(30) Foreign Application Priority Data
Jun. 14, 2021 (SG) 10202106360P

(51) Int. Cl. G06K 9/00; G06K 9/62; G06N 3/08

(52) U.S. Cl. CPC G06K 9/00624; G06K 9/6268; G06N 3/08

(57) ABSTRACT

The embodiments of the present disclosure provide a method and an apparatus for determining object classification. The method may include: performing, by a target detection network, an object detection on a first image, to obtain a first classification confidence of a target object involved in the first image; obtaining an object image comprising a re-detection object from the first image, and performing, by a filter, the object detection on the object image, to determine a second classification confidence of the re-detection object; wherein the re-detection object is the target object whose first classification confidence is within a preset threshold range; correcting the first classification confidence of the re-detection object based on the second classification confidence to obtain an updated confidence; determining a classification detection result of the re-detection object based on the updated confidence.

### CROSS REFERENCE TO RELATED APPLICATION

This application is a continuation application of International Application No. PCT/IB2021/055781 filed on Jun. 29, 2021, which claims priority to Singapore Patent Application No. 10202106360P, filed on Jun. 14, 2021, entitled “METHODS AND APPARATUSES FOR DETERMINING OBJECT CLASSIFICATION”, the disclosures of which are incorporated herein by reference in its entirety for all purposes.

### TECHNICAL FIELD

The present disclosure relates to image processing technology, in particular to a method and an apparatus for determining object classification.

### BACKGROUND

Target detection is an important part of intelligent video analysis system. When performing the target detection, the detection on a target object in a scene (such as a specific object) is desired to have high accuracy, while objects other than the target object can be collectively referred to as foreign things and may cause a false detection during the target object detection, and thereby affecting the subsequent analysis based on the target object.

In the related art, the target object can be detected by a target detection network. However, the accuracy of the target detection network needs to be improved.

### SUMMARY

In view of this, the embodiments of the present disclosure provide at least an object classification detection method and apparatus.

In the first aspect, an object classification detection method is provided, including: performing, by a target detection network, an object detection on a first image to obtain a first classification confidence of a target object involved in the first image, wherein the first classification confidence indicates a confidence that the target object belongs to a first classification; obtaining an object image involving a re-detection object from the first image and performing, by one or more filters, an object detection on the object image, to determine a second classification confidence of the re-detection object, wherein the re-detection object is a target object of which the first classification confidence is within a preset threshold range, and the second classification confidence indicates a confidence that the re-detection object belongs to a second classification; correcting the first classification confidence of the re-detection object based on the second classification confidence, to obtain an updated confidence; determining a classification detection result of the re-detection object based on the updated confidence.

In a second aspect, a target detection method is provided, including: obtaining a to-be-processed image; performing, by a target detection network, an object detection on the to-be-processed image to determine a first classification to which a target object involved in the to-be-processed image belongs, wherein the target detection network is trained with an updated confidence, the updated confidence identifies that a sample object involved in a first image belongs to the first classification, and the updated confidence is obtained by correcting a first classification confidence based on a second classification confidence, the first classification confidence is obtained by identifying the sample object with the target detection network, and the second classification confidence is obtained by identifying the sample object with a filter.

In a third aspect, an object classification detection apparatus is provided, including: a detecting module, configured to perform, by a target detection network, an object detection on a first image, to obtain a first classification confidence of a target object involved in the first image, wherein the first classification confidence indicates a confidence that the target object belongs to a first classification; a re-detection module, configured to obtain an object image involving a re-detection object from the first image, and perform, by one or more filters, an object detection on the object image, to determine a second classification confidence of the re-detection object; wherein the re-detection object is a target object of which the first classification confidence is within a preset threshold range, and the second classification confidence indicates a confidence that the re-detection object belongs to a second classification; a correcting module, configured to correct the first classification confidence of the re-detection object to obtain an updated confidence; a classification determining module, configured to determine a classification detection result of the re-detection object based on the updated confidence.

In a fourth aspect, a target detection apparatus is provided, including: an image obtaining module, configured to obtain a to-be-processed image; an identifying and processing module, configured to perform, by a target detection network, an object detection on the to-be-processed image to determine a first classification to which a target object involved in the to-be-processed image belongs, wherein the target detection network is trained with an updated confidence, the updated confidence identifies that a sample object involved in a first image belongs to the first classification, and the updated confidence is obtained by correcting a first classification confidence based on a second classification confidence, the first classification confidence is obtained by identifying the sample object with the target detection network, and the second classification confidence is obtained by identifying the sample object with a filter.

In a fifth aspect, an electronic device is provided. The device may include a memory, a processor, wherein the memory is configured to store computer-readable instructions and the processor is configured to call the instructions to implement the method described in any of the embodiments of the present disclosure.

In a sixth aspect, a computer-readable storage medium is provided, having a computer program stored thereon, wherein in a case that the computer program is executed by a processor, the method described in any embodiment of the present disclosure is implemented.

In a seventh aspect, a computer program product is provided, including a computer program that when executed by a processor, the method described in any embodiment of the present disclosure is implemented.

In the method and the apparatus for determining object classification provided according to the embodiments of the present disclosure, a first classification confidence obtained by identifying a target object with a target detection network is corrected based on a second classification confidence obtained by identifying the target object with a filter so to obtain an updated confidence, and a classification of the target object is determined based on the corrected updated confidence. As the confidence output from the target detection network is corrected, which makes the identification result of the target detection network more accurate, the classification detection result of the target object is effectively improved to be more accurate.

### BRIEF DESCRIPTION OF THE DRAWINGS

To explain the technical solutions in one or more embodiments of the present disclosure or in related art more clearly, the drawings used in the description of the embodiments or related art will be briefly introduced below. Apparently, the drawings in the following description are only one or more embodiments of the present disclosure. For those of ordinary skill in the art, other embodiments can be obtained based on these drawings without paying creative labor.

FIG. 1 shows a flowchart illustrating a method of determining object classification provided by at least one embodiment of the present disclosures.

FIG. 2 shows a flowchart illustrating a training method of a target detection network according to at least one embodiment of the present disclosure.

FIG. 3 shows a flowchart illustrating a system of confidence correction according to at least one embodiment of the present disclosure.

FIG. 4 shows a flowchart of a target detection method provided by at least one embodiment of the present disclosure. The target detection network in this embodiment may be trained through integrated filters.

FIG. 5 shows a schematic structural diagram of an apparatus for determining object classification according to at least one embodiment of the present disclosure.

FIG. 6 shows a schematic structural diagram of a target detection device according to at least one embodiment of the present disclosure.

### DETAILED DESCRIPTION OF THE EMBODIMENTS

To make a person skilled in the art better understand technical solutions provided by the one or more embodiments of the present disclosure, the technical solutions in the one or more embodiments of the present disclosure will be clearly and completely described below with reference to the accompanying drawings in the one or more embodiments of the present disclosure. Apparently, the embodiments described are merely some embodiments of the present disclosure, and not all embodiments. Based on the one or more embodiments in the present disclosure, all other embodiments obtained by a person of ordinary skill in the art without creative efforts shall fall within the protection scope of the present disclosure.

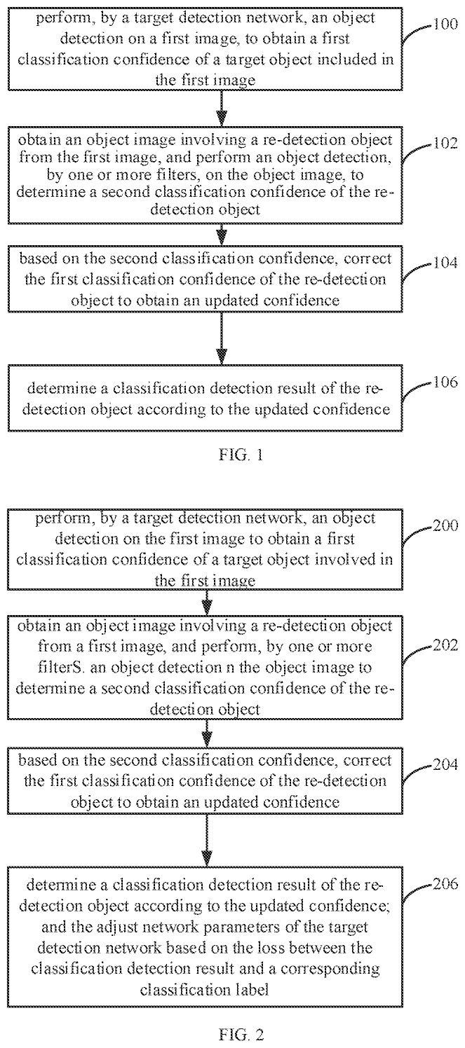

FIG. 1 shows a flowchart illustrating a method of determining object classification provided by at least one embodiment of the present disclosures. As shown in FIG. 1, the method may include the following process.

At step 100, an object detection is performed, by a target detection network, on a first image, to obtain a first classification confidence of a target object involved in the first image.

This embodiment does not limit the structure of the target detection network. For example, the target detection network may be various networks such as Faster region-based convolutional neural network (RCNN), you only look once (YOLO), and single-shot multibox detector (SSD). The first image may include at least one classification of object. For example, the first image may include a poker card and a water cup, then the poker card is an object of one classification and the water cup is an object of another. In this embodiment, the objects to be identified may be referred to as target objects.

The target detection network may output the object classification to which the target object involved in the first image belongs and a classification score by performing object detection on the first image. The object classification can be referred to as the first classification, and the classification score can be referred to as the first classification confidence. For example, “poker card” belongs to a “first classification”. The target detection network can detect that an object in the first image belongs to a “poker card” with a confidence of 0.8, that is, the confidence that the object belongs to the first classification is 0.8. For another example, “water cup” belongs to another “first classification”, and the target detection network can detect that the first classification confidence that another object in the first image belongs to “water cup” is 0.6. In this example, “poker card” and “water cup” can also be referred to as two sub-classifications under the first classification.

At step 102, an object image involving a re-detection object is obtained from the first image, and an object detection is performed, by one or more filters, on the object image, to determine a second classification confidence of the re-detection object.

In this step, on the basis of target objects in the first image are detected in step 100, a re-detection object may also be selected from these target objects, and the re-detection object may be a target object of which the first classification confidence is within a preset threshold range.

For example, suppose that the first image involves a target object O1, a target object O2, and a target object O3, where the first classification confidence that the target object O1 belongs to the first classification “poker card” is 0.8, the first classification confidence that the target object O2 belongs to the first classification “poker card” is 0.75, and the first classification confidence that the target object O3 belongs to the first classification “water cup” is 0.52. Assuming that the preset threshold range is 0.3 to 0.7, it can be seen that the first classification confidence of the target object O3 is within the preset threshold range, then the target object O3 can be referred to as a re-detection object. However, the first classification confidences of the target object O1 and the target object O2 are not within the preset threshold range, thus are not referred to as re-detection objects.

For a re-detection object, an object image involving the re-detection object is obtained from the first image, and the object detection is performed, by a filter, on the object image, to determine a second classification confidence of the re-detection object. The object image is usually smaller than the first image. For example, the first image may include multiple objects such as target objects O1 to O3, and the object image involves only one object, for example, only the target object O3. The object image may be obtained by cropping a corresponding image area according to an object box, identified by the target detection network, involving the target object O3, to obtain the object image involving the target object O3.

The filter may be used to assist in determining the confidence that the re-detection object belongs to the second classification. In an example, the second classification can be the same as the first classification, for example, they are both “water cup”. That is, the target detection network outputs the first classification confidence that the target object O3 belongs to “water cup”, and the filter can also output the second classification confidence that the target object O3 belongs to “water cup”.

In another example, the second classification may also be a classification including the first classification. For example, when the target detection network performs object detection, objects such as a poker card and a water cup are all the targets to be detected by the target detection network, that is, the objects can be collectively referred to as the target objects to be detected and identified by the network. The filter can also be a binary classification network, used to detect whether an object in the object image belongs to a “target classification” or a “non-target classification”, that is, the filter cannot distinguish the specific classification of poker card or water cup. As long as the object is a poker card or a water cup, it belongs to the “target classification”, and the target classification is equivalent to an unified classification of poker card and water cup; otherwise, it belongs to the “non-target classification”. In this case, the second classification “target classification” is a classification that includes the first classification “water cup”, the target detection network outputs the first classification confidence that the target object O3 belongs to “water cup”, and the filter outputs the second classification confidence that the target object O3 belongs to the “target classification” as the re-detection target.

Furthermore, the second classification confidence of the re-detection object determined by the filter may be a direct output result of the filter, or may be a parameter calculated and determined based on the output result of the filter. For example, still taking the binary classification filter that detects “target classification”/“non-target classification” as an example, the filter can directly output the second classification confidence that the re-detected object belongs to the “target classification” is 0.7, or it can output the confidence that re-detection object belongs to the “non-target classification” is 0.3, then “1-0.3=0.7” is calculated as the second classification confidence that the re-detection object belongs to the “target classification”.

At step 104, based on the second classification confidence, the first classification confidence of the re-detection object is corrected to obtain an updated confidence.

In this step, the first classification confidence can be corrected according to the second classification confidence obtained by the filter. This embodiment does not limit the specific manner of correction. For example, the first classification confidence and the second classification confidence may be weighted and integrated to obtain the updated confidence. For example, the weight of the second classification confidence can be set higher when weighting.

The updated confidence may still be within the preset threshold range. For example, the target object whose first classification confidence is within the preset threshold range 0.3 to 0.7 is selected as the re-detection object. After the confidence of the re-detection object is corrected, the updated confidence obtained is still in the range 0.3 to 0.7.

At step 106, a classification detection result of the re-detection object is determined according to the updated confidence.

For example, a way to determine the classification detection result of the re-detection object may be: if the updated confidence is close to a first threshold which is a lower limit of the preset threshold range, then the re-detection object is determined as a foreign thing, that is, it is not the target to be detected by the target detection network; and if the updated confidence is close to the second threshold which is an upper limit of the preset threshold range, the classification of the re-detected object is determined as the first classification, that is, it belongs to the first classification originally identified by the target detection network. See the following example for details:

Assuming that the preset threshold range is 0.3 to 0.7, then 0.3 can be referred to as the first threshold, and 0.7 can be referred to as the second threshold. A third threshold and a fourth threshold can also be set, where the third threshold is greater than or equal to the first threshold while less than the second threshold, and the fourth threshold is less than or equal to the second threshold and greater than the third threshold, for example, The third threshold may be 0.45, and the fourth threshold may be 0.55.

In this case, if the updated confidence is lower than or equal to the third threshold, it can be determined that the classification of the re-detection object is a classification of foreign things other than the second classification. For example, if the updated confidence is 0.4, which is less than the third threshold 0.45, it can be considered that the re-detection object belongs to a non-target classification.

And/or, if the updated confidence is within a range from the fourth threshold to the second threshold (that is, a range greater than or equal to the fourth threshold and less than or equal to the second threshold, where the fourth threshold may be equal to the second threshold), it is can be determined that the re-detection object is of the first classification. For example, the updated confidence is 0.65, which is within a range of 0.55 to 0.7, and it can be determined that the re-detection object belongs to the first classification “water cup”.

This embodiment does not limit the manner of determining the classification detection result of the re-detection object based on the updated confidence, and is not limited to the manner in the foregoing example. For example, the updated confidence and the corresponding classification can also be output directly as the classification detection result.

In this embodiment, the first classification confidence obtained by the target detection network detecting the target object is corrected based on the second classification confidence obtained by a filter detecting the target object. The target object classification is determined based on the corrected updated confidence, so that the confidence output by the target detection network is corrected, which makes the identification result of the target detection network more accurate. As a result, the classification detection result of the target object based on the updated confidence is also more accurate.

The process in FIG. 1 can be applied to an inference stage of the target detection network, and can also be applied to a training stage of the target detection network. For example, if the method of determining object classification illustrated in FIG. 1 is applied to the inference stage, it is equivalent to post-processing the output result of the target detection network through the output result of the filter, and determine the classification of the target object based on the corrected update confidence. If the method of determining object classification illustrated in FIG. 1 is applied to the training stage of the target detection network, network parameters of the target detection network can be adjusted based on the updated confidence. Since the updated confidence after the correction is more accurate, it can also improve the training performance of the target detection network.

As follows, the method of determining object classification is applied to the training stage of the target detection network, and the process of training the target detection network is described. In the training method of the target detection network, a filter is added. The filter is integrated into the target detection network, and the target detection network integrated with the filter is trained. After the training is completed, the filter can be removed in the inference stage of the target detection network.

In the training stage, a first image as the input image of the target detection network may be a sample image for training the network. The first image may be an image involving multiple objects. For example, the first image may include different objects such as people, cars, and trees. The object image input to the filter may include single classification objects, for example, the object image may include only people, or the object image may include only cars.

In an example, the filter may be specifically used to identify a certain specific classification of object. For example, the classification of each target object involved in the first image may all be referred to as the first classification, and the first classification may include multiple sub-classifications. For example, “poker card” is a sub-classification, and “water cup” is a sub-classification. Both the “poker card” and “water cup” are referred to as the first classification. The filter can be used to identify the target object of a specific sub-classification. For example, one of the filters is used to identify “poker card”, that is, the positive samples of the filter during training include poker cards, and the other filter is used to identify “water cup”, that is, the positive samples of the filter during training include water cups. The object image should be input to the filter corresponding to the sub-classification to which the object involved in the object image belongs. For example, an object image involving a poker card is input to a filter for identifying poker cards.

Since the classification of the objects in the object image input to the filter is relatively single, the identification performance of the filter trained to identify the object may be better, and the identification result of the filter can be used to assist in correcting the classification detection result of the target detection network, which makes the classification detection result of the corrected target detection network more accurate, thereby optimizing the training of the target detection network.

FIG. 2 shows a flowchart illustrating a training method of a target detection network according to at least one embodiment of the present disclosure. In the flowchart, the method of determining object classification provided by the embodiments of the present disclosure is used in the training method of the target detection network and the output of the target detection network is corrected by a filter. As shown in FIG. 2, the method may include the following process.

At step 200, object detection is performed, by a target detection network, on a first image to obtain a first classification confidence of a target object involved in the first image.

In the above embodiment, the first image may be a sample image for training the target detection network. The target detection network takes Faster RCNN as an example, but it is not limited in actual implementation. For example, the target detection network can also be other networks such as YOLO and SSD.

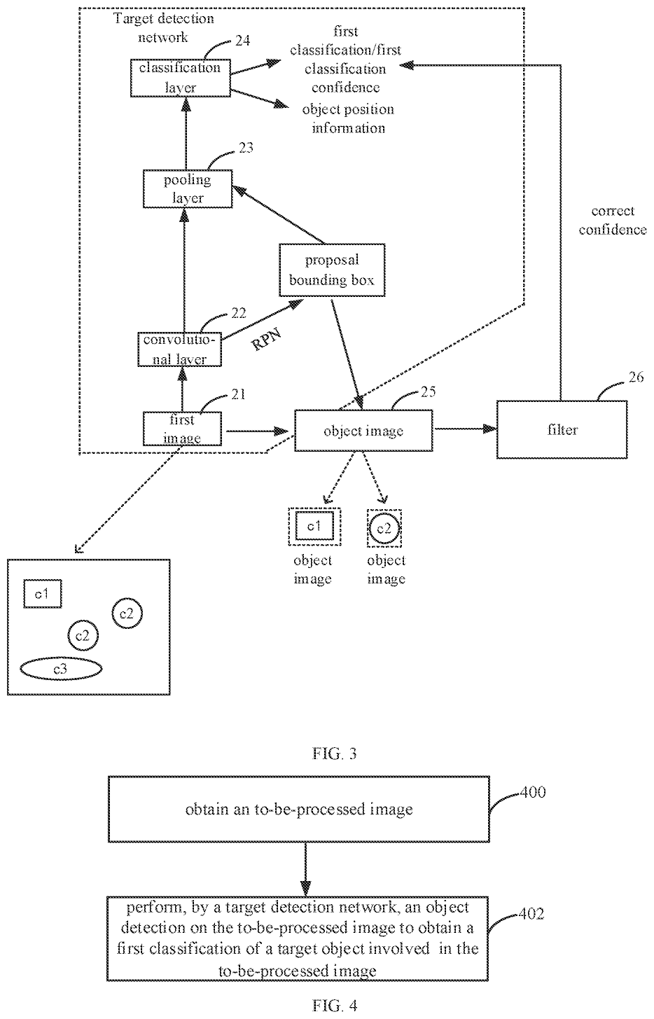

Referring to the schematic of FIG. 3, the first image 21 to be processed is input into the target detection network Faster RCNN. For example, the first image 21 may include multiple classifications of objects. For example, suppose there are three classifications of objects, which are c1, c2, and c3. The first image 21 may include one object of classification c1, two objects of classification c2, and one object of classification c3. The classifications c1, c2, and c3 can all be referred to as the first classification, and the specific classifications can be referred to as sub-classifications in the first classification: sub-classification c1, sub-classification c2, and sub-classification c3.

Then the Faster RCNN may first extract features of the first image 21 through a convolutional layer 22 to obtain a feature map. The feature map is divided into two paths, one is to be processed by a regional proposal network (RPN) which outputs a region proposal. In general, the region proposal can be regarded as many potential bounding boxes (also called proposal bounding box anchor, which is a rectangular box containing four coordinates); the other is to be directly output to a pooling layer 23. Also the proposal bounding boxes output by the RPN are output to the pooling layer 23. The pooling layer 23 may be a region of interest (ROI) pooling, which is used to synthesize the feature maps output by the convolutional layer 22 and the proposal bounding boxes, extract the proposal feature maps, and send them to the subsequent full connection layer for determining the target classification.

Still referring to FIG. 3, the proposal feature maps output by the pooling layer 23 can be sent to a classification layer 24 for further processing, and the sub-classification to which the target object involved in the first image 21 belongs and a classification score are output. In this embodiment, the classification score may be referred to as the first classification confidence. For example, the sub-classification to which one of the objects belongs is c2, and the first classification confidence for the sub-classification c2 is 0.7; the sub-classification to which another target object belongs is c3, and the first classification confidence for the sub-classification c3 is 0.8.

In addition, the classification layer 24 may also output the position information on each target object. The position information is used to define a location area of the target object in the first image, and the position information may specifically be coordinate information on a detection frame involving the target object.

At step 202, an object image involving a re-detection object is obtained from the first image, and the object detection is performed, by one or more filters. on the object image to determine a second classification confidence of the re-detection object.

In this step, the object image 25 can be obtained from the first image 21, where the object image refers to an image involving single classification objects. For example, as shown in FIG. 3, an object image involving a target object of the sub-classification c1, an object image involving a target object of the sub-classification c2 may be cropped from the first image, and these images all include single classification objects. For any target object identified in the first image 21, an object image corresponding to the target object can be obtained respectively.

In actual implementation, among the target objects detected by the target detection network, not all the first classification confidences of the target objects are corrected, but the first classification confidences of some of the target objects can be selected for correction. That is, object images corresponding to at least a part of the target objects can be obtained and input to the filter for processing. For example, a target object of which the first classification confidence is within a preset threshold range may be selected as a re-detection object, and an object image involving the re-detection object can be obtained.

For example: a preset threshold range can be set. This range can be used to filter out “difficult-to-distinguish object” (i.e., the re-detection object). For example, the preset threshold range can be lₜₕᵣₑ<score_{det}<rₜₕᵣₑ, where lₜₕᵣₑ refers to the first threshold, rₜₕᵣₑ refers to the second threshold, and the first threshold is the lower limit of the preset threshold range, the second threshold is the upper limit of the preset threshold range. score_{det} is the first classification confidence obtained by the target detection network. For example, the second threshold may be 0.85, and the first threshold may be 0.3. For example, if the first classification confidence corresponding to the target object is falls into a range between 0.3 and 0.85, the object can be determined as a re-detection object, and the corresponding object image can be obtained.

In addition, it should be noted that the specific numerical range of the preset threshold range can be determined according to actual business requirements. This range is used to define the “difficult-to-distinguish object”, and the filter is required to continue to assist in identifying the object classification.

For example, the method of obtaining the object image may be based on position information on the target object obtained in step 200, and a location area corresponding to the position information is cropped from the first image to obtain the object image. For example, based on the proposal bounding box obtained by the RPN network, the object image may be obtained by cropping the region of the proposal bounding box in the first image 21. For another example, for a single-stage target detection network such as ROLO, the object image can also be obtained directly according to the position information output by the target detection network.

The filter may be pre-trained with a second image, and the second image may be an image involving target objects of the second classification, and the second image may also include single classification objects. Furthermore, each filter can be used to identify a sub-classification object. For example: suppose a certain filter is used to identify the target object of the sub-classification c2, where the target object of the sub-classification c2 can be a poker card. In the training process of the filter, the second image involving the poker card can be used as a positive sample, and an image involving an item similar in appearance to the poker card (such as a bank card, a membership card, etc.) is used as a negative sample to train a binary classification model, which is the filter used to identify the poker card. For another example, when the filter does not distinguish between specific sub-classifications, the image involving the object of the first classification to be identified can be used as a second image training filter. For example, a second image involving a first classification object such as a poker card or a water cup can be used as a positive sample, and an image involving an object other than the first classification object can be used as a negative sample. In this embodiment, take the training of a single filter that identifies a certain sub-classification object as an example.

For example, the output of the filter may include the confidence that the re-detection object belongs to a poker card, for example, the confidence that the re-detection object in the object image is detected as a poker card is 0.8. Otherwise, it can also be the confidence that the re-detection object in the detected object image belongs to a non-poker card. If the confidence of belonging to the non-poker card is 0.4, then “1-0.4=0.6” is the confidence that the object belongs to the poker card. In this embodiment, the confidence that the re-detection object in the object image determined based on the output result of the filter belongs to the second classification is referred to as the second classification confidence.

For example, assuming that the target detection network detects that a target object of the sub-classification c3 is involved in the first image 21, and the first classification confidence that the target object belongs to the sub-classification c3 is 0.7, then the target object is determined as a re-detection object. The object image of the re-detection object is input to the filter corresponding to the sub-classification c3, which is a filter for identifying the target object of the sub-classification c3. By performing object detection with the filter, it can be obtained that the second classification confidence that the re-detected object belongs to the sub-classification c3 is 0.85.

In a case that the first image involves target objects of multiple sub-classifications, there may also be multiple filters, and each filter is used to identify the target object of one sub-classification. For example, three types of filters can be included: “a first filter used to identify objects of sub-classification c1”, “a second filter used to identify objects of sub-classification c2”, and “a third filter used to identify objects of sub-classification c3”, then the object image involving the re-detection object of the sub-classification c1 obtained from the first image can be input into the first filter to obtain the second classification confidence determined by the first filter; in the same way, the object image involving the re-detection object of the sub-classification c2 can be input to the second filter, and the object image involving the re-detection object of the sub-classification c3 is input to the third filter. The object detection is performed by these filters to obtain the corresponding second classification confidence.

In a case that the first image involves objects of only one sub-classification, one filter is sufficient.

At step 204, based on the second classification confidence, the first classification confidence of the re-detection object is corrected to obtain an updated confidence.

In this step, the first classification confidence can be corrected based on the second classification confidence obtained by the filter to obtain an updated confidence.

As mentioned above, the filter is obtained by training with the second image that involves single classification objects, thus the performance of identifying the classification of the target object will be better. Therefore, by correcting the first classification confidence based on the second classification confidence, the corrected updated confidence can be more accurate.

This embodiment does not limit the specific manner of correction. For example, the first classification confidence and the second classification confidence may be weighted and integrated to obtain the updated confidence. For example, when weighting, the weight of the second classification confidence can be set higher.

In a case that the first image involves multiple sub-classifications of target objects, the second classification confidence obtained by the filter corresponding to each sub-classification can be used to correct the first classification confidence that the target object output by the target detection network belongs to the sub-classification. For example, in the above example, the second classification confidence obtained by the “second filter used to identify objects of sub-classification c2” can be used to correct the first classification confidence that the re-detection object output by the target detection network belongs to the sub-classification c2.

An example is a method of correcting the first classification confidence based on the second classification confidence: suppose that in the preset threshold range corresponding to the re-detection object, the lower limit is the first threshold and the upper limit is the second threshold. The confidence increment within the preset threshold range may be determined according to the difference between the second threshold and the first threshold and the second classification confidence; where a confidence increment is added on a basis of the first threshold to obtain the updated confidence.

Referring to the following equations:

score_{new}=lₜₕᵣₑ+(rₜₕᵣₑ−lₜₕᵣₑ)*score_{filter} (1)

where score_{filter} can be the second classification confidence obtained by the filter, score_{new} can be the updated confidence, (rₜₕᵣₑ−lₜₕᵣₑ)*score_{filter} can be the confidence increment within the preset threshold range.

In this embodiment, assuming that the second classification is the same as the first classification, for example, they are both the classification of “poker card”, and the filter is used to identify the confidence that an object belongs to the poker card. Then, the above equation means that if the second classification confidence that the target object, determined by filter, belongs to the second classification is higher, the updated confidence is closer to the second threshold, that is, the probability that the re-detection object belongs to the poker card is higher; if the second classification confidence that the target object, determined by filter, belongs to the second classification is lower, the updated confidence is closer to the first threshold, that is, the probability that the re-detection object belongs to the poker card is lower. However, the updated confidence will still be within the preset threshold range.

For example, lₜₕᵣₑ can be 0.3, rₜₕᵣₑ can be 0.85. Assuming that the first classification confidence corresponding to the target object of the sub-classification c1 obtained by the target detection network is 0.6, which is within the preset threshold range, the object is determined as a re-detection object. The object image corresponding to the re-detection object is input to the filter corresponding to the sub-classification c1 (that is, the filter used to identify the target object of classification). According to an output result of the filter, it is determined that the second classification confidence that the re-detection object belongs to the sub-classification c1 is 0.78. According to the equation (1), the calculation is as follows:

score_{new}=0.3+(0.85−0.3)*0.78=0.729

The 0.729 can be used directly to replace the first classification confidence 0.6 output by the target detection network.

As above, through the above correction process, it can be seen that initially, the first classification confidence that the target object belongs to the sub-classification c1 output by the target detection network is 0.6, and the second classification confidence that the target object belongs to the sub-classification c1 obtained by the filter is 0.78, which shows that the filter determines that the target object is more likely to belong to the sub-classification c1. The performance of the target detection by the filter trained with the second image is better than that of the target detection network, so the identification result of the filter can be more trusted. Therefore, after calculating by equation (1), the initial first classification confidence of 0.6 is updated to 0.729. Compared with 0.6, the updated confidence of 0.729 is closer to the second threshold of 0.85, but it is still in the preset threshold range (0.3, 0.85).

With the correction process, the filter can assist the target detection network to enhance a resolution of the target detection network for identifying the classification of an object, thereby improving the resolution for a re-detection object. For example, the first classification confidence that the target object identified by the target detection network belongs to the sub-classification c1 is 0.6, that is, the probability that the target detection network determines the target object belongs to the sub-classification c1 is not high. However, the filter determines that the probability that the target object belongs to the sub-classification c1 is higher, that is the second classification confidence is 0.78, which assists the target detection network to correct the original 0.6 to 0.729, and helps the target detection network to approach a more accurate detection result, thereby improving the resolution. The increase in resolution helps to better train the target detection network, making it more accurate to adjust network parameters.

At step 206, the classification detection result of the re-detection object is determined according to the updated confidence; and network parameters of the target detection network are adjusted based on a loss between the classification detection result and a corresponding classification label.

For the first image as the training sample image, each target object in the first image may correspond to a classification label, that is, the true classification of the target object. The classification detection result of the re-detection object can be determined based on the updated confidence obtained after the correction, and the network parameters of the target detection network can be adjusted based on the loss between the classification detection result and the corresponding classification label.

For example, the classification detection result of the target object originally output by the target detection network is (0.2, 0.6, 0.2), where the three elements in the classification detection result are the first classification confidences that the target object belongs to sub-classifications c1, c2, and c3, and 0.6 is the first classification confidence that the target object belongs to the sub-classification c2. Through the second classification confidence that the target object belongs to the sub-classification c2 output by the filter, 0.6 is corrected to 0.729, and the classification detection result of the target object is corrected to (0.2, 0.729, 0.2), or the three elements in the classification detection result can be normalized. Assuming that the classification label of the target object is (0, 1, 0), the loss between the classification detection result and the corresponding classification label can be calculated through a loss function, and the network parameters of the target detection network can be adjusted accordingly. In the actual training process, the parameters can be adjusted based on the loss of a sample set having a plurality of samples, which will not be described in detail.

In the training method of the target detection network of this embodiment, a first classification confidence of the target detection network is corrected by using the second classification confidence obtained from the filter, which can make the obtained updated confidence more accurate. In addition, the network parameters of the target detection network are adjusted based on the updated confidence to obtain better training performance, thereby improving the identification accuracy of the target detection network. Furthermore, the acquisition of the training samples in this training method is less difficult and less costly.

For example, suppose that the input images of the target detection network includes not only poker cards, but also bank cards and membership cards, and the purpose of the target detection network is to identify the poker card. In related art, images involving poker cards and items of other classifications are directly used as samples to train the target detection network. However, the disadvantage of this method is that, on one hand, inputting image samples involving poker cards and items of other classifications makes it more difficult for acquisition, that is, it is difficult to obtain images that meet the requirements in the real scene; on the other hand, for the image samples involving poker cards and items of other classifications, the identification performance of the trained network needs to be improved, and false detections may occur. For example, the target detection network may also identify a membership card in an input image as a poker card, but the membership card is actually a foreign thing, which causes a false detection. Therefore, the identification accuracy of the target detection network needs to be improved.

In the training method provided by the embodiments of the present disclosure, on the one hand, the filter is trained using sample object images involving single classification objects, which is easier for the acquisition on the sample object images, the difficulty of sample acquisition is reduced; on the other hand, since the filter is trained with the sample object images involving single classification objects, which makes the filter more accurate in the identification of the target classification object. The output result of the filter is further corrected based on the output result of the target detection network, which also improves the accuracy of the output result of the target detection network, thereby making the performance of the identification of the target detection network and reducing the occurrence of the false detections. For example, after training through the training method of the embodiments of the present disclosure, the target detection network may reduce the occurrence of identifying a membership card as a poker card.

In addition, the number of filters and the number of object classification to be identified by the target detection network may not be consistent. For example, there are three classifications of target objects to be detected by the target detection network: c1, c2, and c3. All the three filters can be used to identify these classifications respectively, or only one or two of the three filters can be used to improve the training performance of the target detection network to some extent.

The above is an example of applying the method of determining object classification according to the embodiments of the present disclosure to the training process of the target detection network. The process can also be applied to the inference stage of the target detection network, that is, the network application stage. For example, in the network application stage, the updated confidence can be calculated according to equation (1); or a plurality of filters can be used to correct the first classification confidence of target objects of different sub-classifications. Detailed process can be combined with the description of the training stage.

In addition, whether it is the network application stage or the network training stage of the target detection network, the method can be applied to a game scene. The first image can be a game image of a gaming place. For example, the gaming place can be provided with multiple game tables, a camera can be set above each game table to collect the game process occurring on the game table, and the image involving the game table collected by the camera can be referred to as the first image. The target object in the first image can be a game item in the gaming place. For example, when the gaming people are participating in a game on a game table, they can use specific game items. Then, the first image collected by the camera can include the game items on the game table.

FIG. 4 shows a flowchart of a target detection method provided by at least one embodiment of the present disclosure. The target detection network in this embodiment may be trained through integrated filters. As shown in FIG. 4, the method may include the following process:

At step 400, a to-be-processed image is obtained.

This embodiment does not limit the classification of the to-be-processed image, and the image can be any image of the target object to be identified. For example, it can be an image involving a sports scene, and each athlete in the image is to be identified. For another example, it can also be an image involving a table, and the books on the table are to be identified. For another example, it can also be a game image, a game item in a gaming place is to be identified, such as a poker card.

The classification of a target object to be identified in the to-be-processed image may be a plurality, and the number of objects of each classification may also be a plurality, which is not limited in this embodiment.

At step 402, an object detection is performed, by a target detection network, on the to-be-processed image to obtain a first classification of a target object involved in the to-be-processed image.

The target detection network used in this step may be a network trained by the training method described in any embodiment of the present disclosure. For example, in the training process of the target detection network, a filter can be integrated. The target detection network can identify the first classification confidence of the sample object in the first image used for training, and the sample object is the target object involved in the first image input during the training of the target detection network. The second classification confidence of the sample object is identified by the filter, and the first classification confidence is corrected based on the second classification confidence to obtain the updated confidence, and the target detection network is trained according to the updated confidence. The detailed training process can be seen in the process shown in FIG. 2, which will not be described in detail again.

In the target detection method of this embodiment, the first classification confidence of the target detection network is corrected by using the second classification confidence obtained by the filter, and the network parameters of the target detection network are adjusted based on the updated confidence obtained after the correction, thereby making the training performance better, and improving the identification accuracy of the target detection network. As a result, the accuracy of object identification is higher using the trained target detection network.

FIG. 5 shows a schematic structural diagram of an apparatus for determining object classification provided by at least one embodiment of the present disclosure. As shown in FIG. 5, the apparatus may include: a detecting module 51, a re-detection module 52, a correction module 53 and a classification determining module 54.

The detecting module 51 is configured to perform, by a target detection network, an object detection on a first image, to obtain a first classification confidence of a target object involved in the first image, wherein the first classification confidence indicates a confidence that the target object belongs to a first classification.

The re-detection module 52 is configured to obtain an object image involving a re-detection object from the first image, and perform an object detection on the object image with one or more filters, to determine a second classification confidence of the re-detection object; wherein the re-detection object is a target object of which the first classification confidence is within a preset threshold range, and the second classification confidence indicates a confidence that the re-detection object belongs to a second classification.

The correcting module 53 is configured to correct the first classification confidence of the re-detection object to obtain an updated confidence.

The classification determining module 54 is configured to determine a classification detection result of the re-detection object based on the updated confidence.

In an example, the detecting module 51 is further configured to: by performing, by the target detection network, the object detection on the first image, position information corresponding to the target object is further obtained for defining a location area of the target object in the first image; in a case that the re-detection module 52 is configured to obtain an object image involving a re-detection object from the first image: based on the position information corresponding to the re-detection object, crop a location area corresponding to the position information from the first image to obtain the object image involving the re-detection object.

In an example, in a case that the correcting module 53 is configured to correct the first classification confidence of the re-detection object to obtain the updated confidence, correct the first classification confidence of the re-detection object based on the second classification confidence to determine the updated confidence within the preset threshold range; wherein, higher the second classification confidence is, closer the updated confidence is to the second threshold; lower the second classification confidence is, closer the updated confidence is to the first threshold; and a lower limit of the preset threshold range is a first threshold and an upper limit of the preset threshold range is a second threshold.

In an example, in a case that the correcting module 53 is configured to correct the first classification confidence of the re-detection object to obtain the updated confidence: perform weighted integration on the first classification confidence and the second classification confidence of the re-detection object to obtain the updated confidence.

In an example, in a case that the detecting module 51 is configured to perform, by the target detection network, the object detection on the first image, to obtain the first classification confidence of the target object involved in the first image, perform, by the target detection network, the object detection on the first image to obtain respective first sub-classification confidences, wherein each of the respective first sub-classification confidence indicates a confidence that at least one target object involved in the first image belong to each of the sub-classifications.

In a case that the re-detection module 52 is configured to perform, an object detection on the object image with one or more filters, to determine the second classification confidence of the re-detection object, for any re-detection object, according to a target sub-classification corresponding to the re-detection object, input the object image corresponding to the re-detection object to a filter corresponding to the target sub-classification; perform an object detection on the object image with the filter corresponding to the target sub-classification to determine the second classification confidence of the re-detection object.

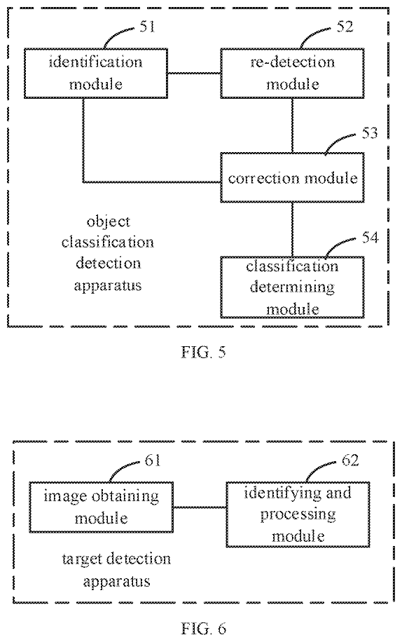

FIG. 6 shows a schematic structural diagram of a target detection apparatus according to at least one embodiment of the present disclosure. As shown in FIG. 6, the apparatus may include an image obtaining module 61 and an identifying and processing module 62.

The image obtaining module 61 is configured to obtain a to-be-processed image;

The identifying and processing module 62 is configured to perform, by a target detection network, an object detection on the to-be-processed image to determine a first classification to which a target object involved in the to-be-processed image belongs, wherein the target detection network is trained with an updated confidence, the updated confidence identifies that a sample object involved in a first image belongs to the first classification, and the updated confidence is obtained by correcting a first classification confidence based on a second classification confidence, the first classification confidence is obtained by identifying the sample object with the target detection network, and the second classification confidence is obtained by identifying the sample object with a filter

In some embodiments, the above-mentioned apparatus may be used to execute any corresponding method described above, and for the sake of brevity, it will not be repeated here.

An embodiment of the present disclosure also provides an electronic device. The device includes a memory, a processor, wherein the memory is configured to store computer-readable instructions and the processor is configured to call the instructions to implement the method described in any of the embodiments of the present disclosure.

The embodiments of the present disclosure also provide a computer-readable storage medium on which a computer program is stored, and when the program is executed by a processor, the method of any embodiment of the present specification is implemented.

Those skilled in the art should understand that one or more embodiments of the present disclosure may be provided as a method, a system, or a computer program product. Thus, one or more embodiments of the present disclosure may take the form of an entirely hardware embodiment, an entirely software embodiment, or an embodiment incorporating software and hardware aspects. Moreover, one or more embodiments of the present disclosure may take the form of a computer program product embodied on one or more computer usable storage media (including but not limited to disk memory, CD-ROM, optical memory, etc.) having computer usable program code embodied therein.

An embodiment of the present disclosure further provides a computer readable storage medium, on which a computer program may be stored, and the program is executed by a processor to implement the steps of the training method for a neural network for determining object classification described in any embodiment of the present disclosure, and/or to implement the steps of the method of determining object classification described in any embodiment of the present disclosure.

An embodiment of the present disclosure further provides computer program product, comprising a computer program that when executed by a processor, the method of any embodiment of the present specification is implemented.

Herein, the ‘and/or’ described in the embodiments of the present disclosure means that at least one of the two, for example, ‘A and/or B’ includes three schemes: A, B, and ‘A and B’.

Various embodiments of the present disclosure are described in a progressive manner, and parts similar to each other may be referred to for each other, and each embodiment is emphasized to be different from other embodiments. Especially, for the apparatus embodiment, since the apparatus for determining object classification is basically similar to the method embodiment, the description is relatively simple, and reference may be made to some description of the method embodiment for relevant parts.

The specific embodiments of the present disclosure have been described above. Other embodiments are within the scope of the appended claims. In some cases, the behaviors or steps described in the claims may be performed in an order different from that in the embodiments and the desired results may still be achieved. Moreover, the processes depicted in the figures do not necessarily require the particular order or sequence shown to achieve the desired results. In some embodiments, multitasking and parallel processing are also possible or may be advantageous.

Embodiments of the subject matter and functional operations described in this disclosure may be implemented in digital electronic circuitry, tangibly embodied computer software or firmware, computer hardware including the structures disclosed in this disclosure and structural equivalents thereof, or combinations of one or more thereof. Embodiments of the subject matter described in this disclosure may be implemented as one or more computer programs, i.e., one or more modules of computer program instructions encoded on a tangible non-transitory program carrier to be executed by a data processing apparatus or to control the operation of the apparatus for determining object classification. Alternatively or additionally, program instructions may be encoded on an artificially generated propagating signal, such as a machine-generated electrical, optical or electromagnetic signal, which is generated to encode and transmit information to a suitable receiver device for execution by data processing device. The computer storage medium may be a machine-readable storage device, a machine-readable storage substrate, a random or serial access memory device, or a combination of one or more thereof.

The processes and logic flows described in this disclosure may be performed by one or more programmable computers executing one or more computer programs to perform corresponding functions by operating in accordance with input data and generating an output. The processing and logic flows may also be performed by dedicated logic circuitry, such as a field programmable gate array (FPGA) or an application specific integrated circuit (ASIC), and the apparatus may also be implemented as dedicated logic circuitry.

Computers suitable for executing computer programs include, for example, general purpose and/or special purpose microprocessors, or any other type of central processing unit. Typically, the central processing unit will receive instructions and data from read only memory and/or random access memory. The basic components of the computer include a central processing unit for implementing or executing instructions and one or more memory devices for storing instructions and data. Typically, the computer will also include one or more mass storage devices for storing data, such as magnetic disks, magneto-optical disks or optical disks, or the like, or the computer will be operatively coupled with such mass storage devices to receive data therefrom or to transfer data thereto, or both. However, a computer does not necessarily have such a device. In addition, the computer may be embedded in another device, such as a mobile phone, a personal digital assistant (PD many), a mobile audio or video player, a game console, a global positioning system (GPS) receiver, or a portable storage device such as a universal serial bus (USB) flash drive, to name a few.

Computer readable media suitable for storing computer program instructions and data include all forms of non-volatile memory, media, and memory devices, including, for example, semiconductor memory devices (e.g., EPROM, EEPROM, and flash memory devices), magnetic disks (e.g., internal hard disks or removable disks), magneto-optical disks, and CD ROM and DVD-ROM disks. The processor and the memory can be supplemented by or incorporated into a dedicated logic circuit.

While this disclosure includes numerous specific implementation details, these should not be construed as limiting the scope of any disclosure or claimed, but rather are primarily used to describe the features of particular disclosed embodiments. Certain features described in various embodiments within the present disclosure may also be implemented in combination in a single embodiment. On the other hand, the various features described in a single embodiment may also be implemented separately in multiple embodiments or in any suitable sub-combination. Moreover, while features may function in certain combinations as described above and even initially so claimed, one or more features from the claimed combination may in some cases be removed from the combination, and the claimed combination may point to a variation of the sub-combination or sub-combination.

Similarly, while operations are depicted in a particular order in the figures, this should not be understood as requiring these operations to be performed in the particular order shown or in order, or requiring all of the illustrated operations to be performed to achieve the desired result. In some cases, multitasking and parallel processing may be advantageous. Moreover, the separation of various system modules and components in the above embodiments should not be construed as requiring such separation in all embodiments, and it should be understood that the described program components and systems may generally be integrated together in a single software product or encapsulated into multiple software products.

Thus, particular embodiments of the subject matter have been described. Other embodiments are within the scope of the appended claims. In some cases, the acts described in the claims may be performed in different orders and still achieve the desired results. Moreover, the processes depicted in the figures are not necessarily the particular order or order shown to achieve the desired results. In some implementations, multitasking and parallel processing may be advantageous.

The foregoing description is merely exemplary embodiments of one or more embodiments of the present disclosure, and is not intended to limit one or more embodiments of the present disclosure. Any modifications, equivalent replacements, improvements, etc. made within the spirit and principle of one or more embodiments of the present disclosure should be included within the scope of protection of one or more embodiments of the present disclosure.

1. A method of determining object classification, comprising:
performing, by a target detection network, an object detection on a first image to obtain a first classification confidence of a target object involved in the first image, wherein the first classification confidence indicates a confidence that the target object belongs to a first classification;
obtaining an object image involving a re-detection object from the first image and performing by one or more filters, an object detection on the object image, to determine a second classification confidence of the re-detection object, wherein the re-detection object is a target object of which the first classification confidence is within a preset threshold range, and the second classification confidence indicates a confidence that the re-detection object belongs to a second classification;
correcting the first classification confidence of the re-detection object based on the second classification confidence, to obtain an updated confidence;
determining a classification detection result of the re-detection object based on the updated confidence.

2. The method of claim 1, wherein,
by performing, by the target detection network, the object detection on the first image, position information corresponding to the target object is further obtained for defining a location area of the target object in the first image;
obtaining the object image involving the re-detection object from the first image comprises: based on the position information corresponding to the re-detection object, cropping a location area corresponding to the position information from the first image to obtain the object image involving the re-detection object.

3. The method of claim 1, wherein a lower limit of the preset threshold range is a first threshold and an upper limit of the preset threshold range is a second threshold; correcting the first classification confidence of the re-detection object based on the second classification confidence, to obtain the updated confidence comprises:
correcting the first classification confidence of the re-detection object based on the second classification confidence to determine the updated confidence within the preset threshold range; wherein,
higher the second classification confidence is, closer the updated confidence is to the second threshold;
lower the second classification confidence is, closer the updated confidence is to the first threshold.

4. The method of claim 3, wherein correcting the first classification confidence of the re-detection object based on the second classification confidence to determine the updated confidence within the preset threshold range, comprises:
determining a confidence increment within the preset threshold range based on the following: a difference between the second threshold and the first threshold, and the second classification confidence;
obtaining the updated confidence by adding the confidence increment on a basis of the first threshold.

5. The method of claim 3, wherein determining the classification detection result of the re-detection object based on the updated confidence comprises:
in a case that the updated confidence is lower than or equal to a third threshold, determining the re-detection object is a foreign thing other than the second classification;
and/or in a case that the updated confidence is within a range from a fourth threshold to the second threshold, determining the re-detection object is of the first classification;
wherein the third threshold is greater than or equal to the first threshold, while less than the second threshold;
the fourth threshold is less than or equal to the second threshold, while greater than the third threshold.

6. The method of claim 1, wherein correcting the first classification confidence of the re-detection object based on the second classification confidence, to obtain the updated confidence comprises:
performing weighted integration on the first classification confidence and the second classification confidence of the re-detection object to obtain the updated confidence.

7. The method of claim 1, wherein the first classification comprises one or more sub-classifications, each of the one or more filters is used for detecting a target object of one of the one or more sub-classifications;
performing, by the target detection network, the object detection on the first image, to obtain the first classification confidence of the target object involved in the first image comprises:
performing, by the target detection network, the object detection on the first image to obtain respective first sub-classification confidences, wherein each of the respective first sub-classification confidence indicates a confidence that at least one target object involved in the first image belong to each of the sub-classifications;
performing an object detection on the object image with one or more filters, to determine the second classification confidence of the re-detection object comprises:
for any re-detection object, according to a target sub-classification corresponding to the re-detection object, inputting the object image corresponding to the re-detection object to a filter corresponding to the target sub-classification;
performing an object detection on the object image with the filter corresponding to the target sub-classification, to determine the second classification confidence of the re-detection object.

8. The method of claim 1, wherein the one or more filters are trained with a second image involving a target object of the second classification.

9. The method of claim 1, wherein
the second classification and the first classification are a same classification, or
the second classification comprises the first classification.

10. The method of claim 1, wherein the first image is a sample image for training the target detection network; after determining the classification detection result of the re-detection object based on the updated confidence, the method further comprises:
obtaining a loss between the classification detection result of the re-detection object and a corresponding classification label;
adjusting a network parameter of the target detection network based on the loss.

11. The method of claim 1, wherein
the first image is an image of a gaming place; and
the target object is a game item in the gaming place.

12. A method of target detection, comprising:
obtaining a to-be-processed image;
performing, by a target detection network, an object detection on the to-be-processed image to determine a first classification to which a target object involved in the to-be-processed image belongs, wherein
the target detection network is trained with an updated confidence, the updated confidence identifies that a sample object involved in a first image belongs to the first classification, and
the updated confidence is obtained by correcting a first classification confidence based on a second classification confidence, the first classification confidence is obtained by identifying the sample object with the target detection network, and the second classification confidence is obtained by identifying the sample object with a filter.

13. An electronic device, comprising: a memory, a processor, wherein the memory is configured to store computer-readable instructions and the processor is configured to call the instructions to implement a method of determining object classification, comprising:
performing, by a target detection network, an object detection on a first image to obtain a first classification confidence of a target object involved in the first image, wherein the first classification confidence indicates a confidence that the target object belongs to a first classification;
obtaining an object image involving a re-detection object from the first image and performing by one or more filters, an object detection on the object image, to determine a second classification confidence of the re-detection object, wherein the re-detection object is a target object of which the first classification confidence is within a preset threshold range, and the second classification confidence indicates a confidence that the re-detection object belongs to a second classification;
correcting the first classification confidence of the re-detection object based on the second classification confidence, to obtain an updated confidence;
determining a classification detection result of the re-detection object based on the updated confidence.
